(19) United States
(12) Patent Application Publication
(10) Pub. No.: US 2019/0191914 A1
(43) Pub. Date: Jun. 27, 2019

(54) COFFEE FILTER HOLDER

(71) Applicant: Rudolf Schillheim, Eslohe (DE)

(72) Inventor: Rudolf Schillheim, Eslohe (DE)

(21) Appl. No.: 16/198,825

(22) Filed: Nov. 22, 2018

(30) Foreign Application Priority Data
Dec. 21, 2017 (DE) 202017006551.7

(51) Int. Cl. A47J 31/06

(52) U.S. Cl. CPC A47J 31/0605; A47J 31/0626

(57) ABSTRACT

A coffee filter holder configured to be placed on a coffee pot and to receive a filtering arrangement that is at least partially filled with coffee powder, the coffee filter holder including a conical receiver for the filtering arrangement, the conical receiver including a base side pass through opening and a base plate configured to support the coffee filter holder on the coffee pot; and a valve arrangement that is arranged below the base plate wherein the valve arrangement is actuated by a weight of the coffee filter holder when the coffee filter holder is placed on the coffee pot.

### RELATED APPLICATIONS

This application claims priority from and incorporates by reference German patent application DE 20 2017 006 551.7 filed on Dec. 21, 2017.

### FIELD OF THE INVENTION

The invention relates to a coffee filter holder.

### BACKGROUND OF THE INVENTION

A coffee filter holder of this generic type is well known in the art and used with good success in millions of households. However, contaminations of the environment may occur when handling the coffee filter holder, in particular when transporting the coffee filter holder to a pot or a cup or to another pot or cup.

### BRIEF SUMMARY OF THE INVENTION

Thus, it is an object of the invention to provide a new coffee filter holder which reliably prevents any environmental contamination during handling.

The object is achieved by a coffee filter holder configured to be placed on a coffee pot and to receive a filtering arrangement that is at least partially filled with coffee powder, the coffee filter holder including a conical receiver for the filtering arrangement, the conical receiver including a base side pass through opening and a base plate configured to support the coffee filter holder on the coffee pot; and a valve arrangement that is arranged below the base plate wherein the valve arrangement is actuated by a weight of the coffee filter holder when the coffee filter holder is placed on the coffee pot.

The coffee filter holder according to the invention has the essential advantage that the flow through opening is automatically closed when lifting the coffee filter holder so that a dripping of the coffee filter holder is reliably prevented when moving the coffee filter holder to another location.

In an advantageously embodiment of the invention the valve arrangement is formed by a closure element that is arranged below the pass through opening and a radially extending rocker arm that is connected with the closure element and spring loaded in a closing direction. Advantageously the valve arrangement opens automatically when the coffee filter holder is placed on a coffee pot since the coffee filter holder automatically rests on the rocker arm and the rocker arm opens the valve due to the weight of the coffee filter holder. When lifting the coffee filter holder the valve is automatically closed again and reliable drip protection is achieved.

Advantageously the closure element can be configured as a silicone gasket by which the pass through opening is closable.

### BRIEF DESCRIPTION OF THE DRAWINGS

Further advantages of the invention can be derived from the subsequent description of an embodiment with reference to drawing figures, wherein:

FIG. 1 illustrates a side view of a coffee filter holder;

FIG. 2 illustrates sectional view of the coffee filter illustrated in FIG. 1; and

FIG. 3 illustrates a sectional view through a coffee pot with the coffee filter holder according to FIG. 2.

### DETAILED DESCRIPTION OF THE INVENTION

In the drawing figures, a coffee filter holder is overall designated with the reference numeral 10.

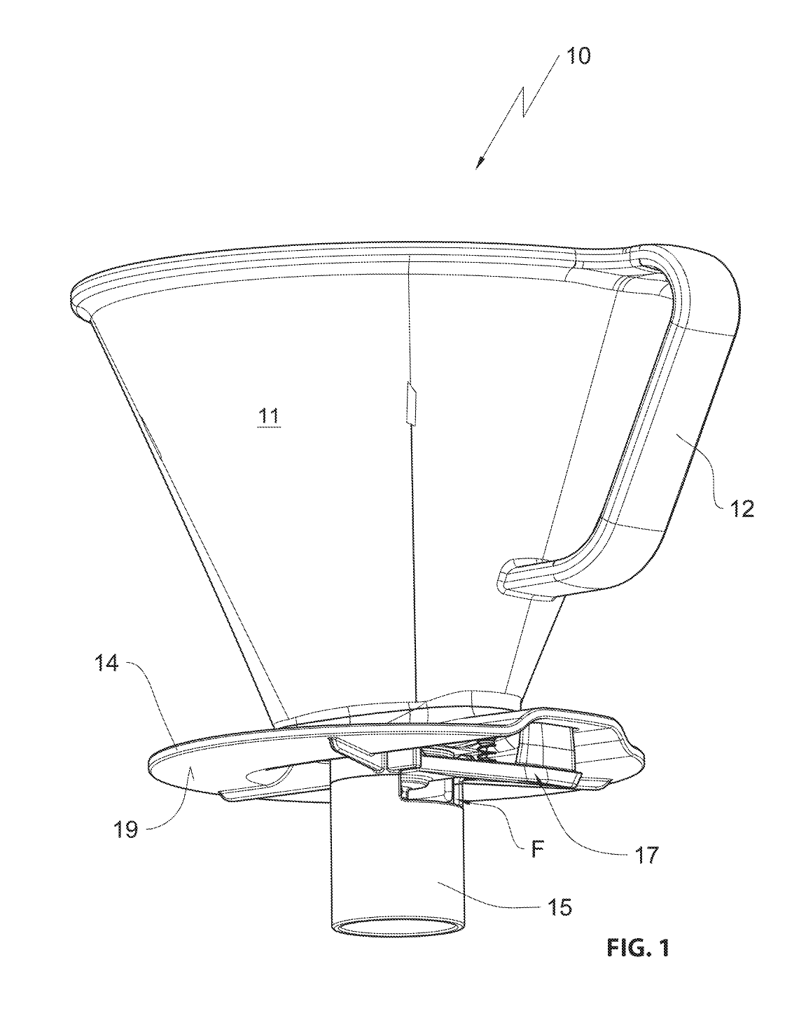

FIG. 1 illustrates a coffee filter holder 10 that includes a funnel 11 for receiving the non-illustrated coffee filter. The funnel 11 has a free form transition shape wherein the upper opening is circular and the base portion is oval. In the operating condition a non-illustrated filter arrangement is arranged in the funnel 11 of the coffee filter holder 10 wherein the filter arrangement is configured as a paper filter or as a permanent filter configured as a reusable stainless steel or synthetic material filter.

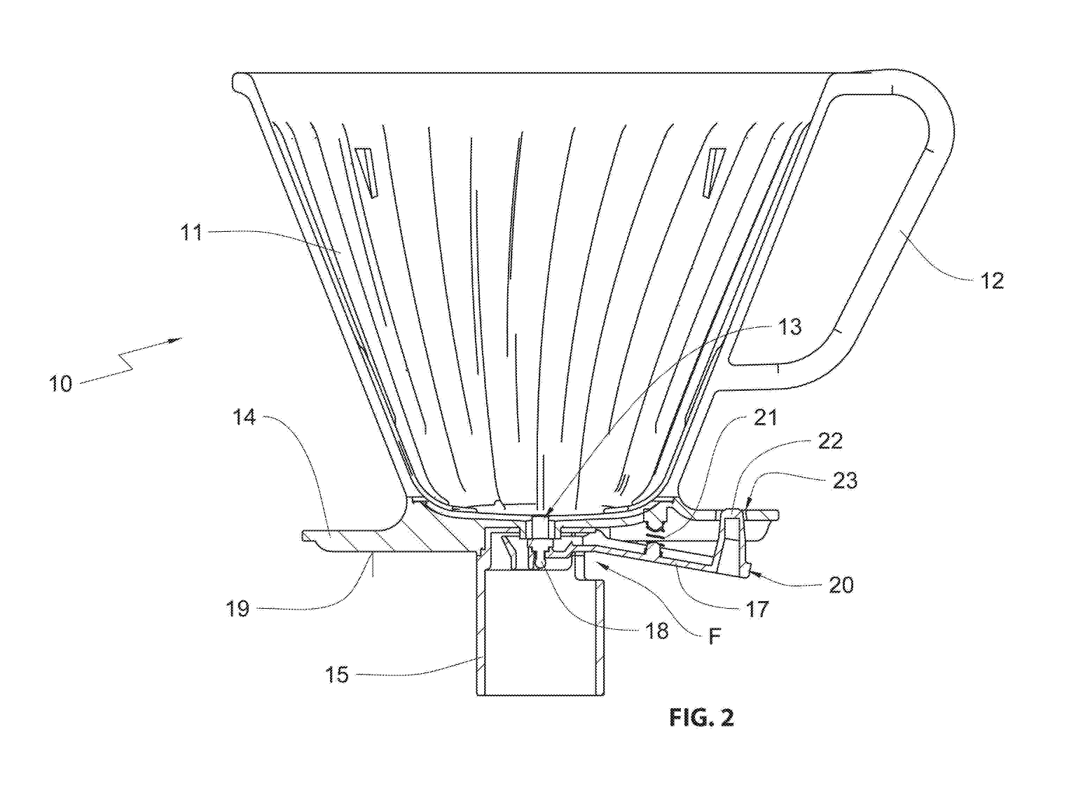

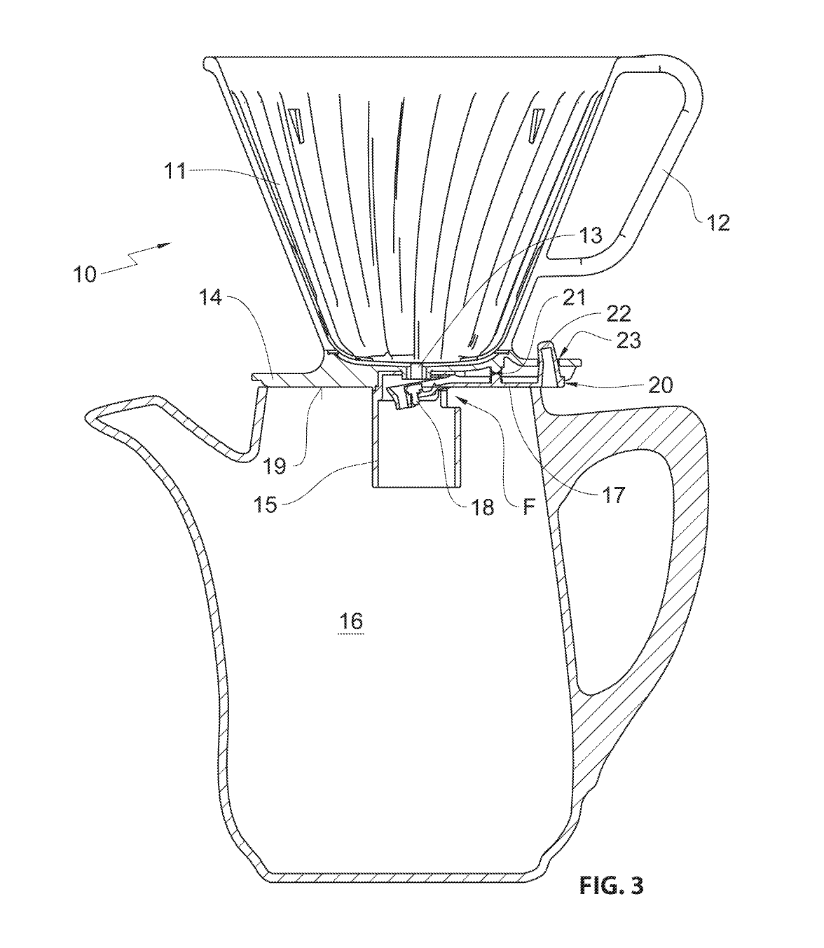

A handle 12 is arranged at the outer circumference of the funnel element 11. In the base portion the funnel 11 is provided with a pass through opening 13 (c.f. FIG. 2). Below or laterally from the base portion of the filter 11 a circular plate 14 with a tubular extension 15 is arranged. Below the plate 14 that is used for supporting the coffee filter holder on a coffee pot 16 (FIG. 3) a rocker arm 17 is arranged that extends in a radial outward direction from the portion below the pass through opening 13 through a window opening (F) wherein the rocker arm is pivotally supported at the coffee filter holder 10 between the portion of the pass through opening 13 and a free end portion 20. The rocker arm 17 includes a silicone seal element 18 below the pass through opening 13 and a compression spring 21 is arranged between the pivot lever 17 and a bottom surface 19 of the plate 14 between the non-illustrated joint and the free end 20 of the pivot lever 17 wherein the compression spring provides that the pass through opening 13 is closed drip tight by the silicone seal 18 in a position where the coffee filter holder is not placed on a coffee pot 16 (c.f. FIG. 2). It is appreciated that that the seal 18 can also be made from other seal materials.

Only when the coffee filter holder is placed on the coffee pot 16 according to FIG. 3 the pivot lever 17 moves into the impact portion of the upper edge portion of the coffee pot 16 wherein the weight of the coffee filter holder 10 moves the pivot lever 17 counter clock wise upward until the pivot lever contacts the bottom side of the plate 14. In order to better support the pivot lever 17 the free end portion 20 is furthermore provided with a protrusion 22 which reaches through a pass through opening 23 in the plate in an open condition of the valve arrangement (c.f. FIG. 3).

Using the illustrated coffee filter holder 10 it is advantageously possible to fill individual cups, beakers or also other coffee pots one after the other without contaminating the environment when moving the coffee filter holder 10 onto a new container that is to be filled.

### REFERENCE NUMERALS AND DESIGNATIONS

10 coffee filter holder

11 funnel

12 handle

13 pass through opening

14 plate

15 tubular extension

16 coffee pot

17 pivot lever

18 silicone seal

19 bottom surface of plate

20 free end of pivot lever 17

21 compression spring

22 protrusion of 17

23 pass through opening

F window opening.

What is claimed is:

1. A coffee filter holder configured to be placed on a coffee pot and to receive a filtering arrangement that is at least partially filled with coffee powder, the coffee filter holder comprising:
a conical receiver for the filtering arrangement, the conical receiver including a base side pass through opening and a base plate configured to support the coffee filter holder on the coffee pot; and
a valve arrangement that is arranged below the base plate wherein the valve arrangement is actuated by a weight of the coffee filter holder when the coffee filter holder is placed on the coffee pot.

2. The coffee filter holder according to claim 1, wherein the valve arrangement includes a closure element that is arranged below the pass through opening and a radially extending pivot arm that is connected with the closure element and spring loaded in a closing direction.

3. The coffee filter holder according to claim 1, wherein the closure element is configured as a silicone seal by which the pass through opening is closable.
